(19) United States
(12) Patent Application Publication
(10) Pub. No.: US 2024/0343659 A1
(43) Pub. Date: Oct. 17, 2024

(54) AGRICULTURAL COMPOSITIONS AND RELATED METHODS

(71) Applicant: SETATECH USA, INC., Homestead, FL (US)

(72) Inventors: Blair BLACKER, Homestead, FL (US); Lisa CHEN, Homestead, FL (US)

(21) Appl. No.: 18/637,560

(22) Filed: Apr. 17, 2024

Related U.S. Application Data
(60) Provisional application No. 63/459,801, filed on Apr. 17, 2023.

(51) Int. Cl. C05F 1/00; C05C 11/00; C05F 11/00; C05F 17/90

(52) U.S. Cl. CPC C05F 1/005; C05C 11/00; C05F 11/00; C05F 17/90

(57) ABSTRACT

Agricultural compositions are provided that at least one keratin protein isolated from at least one feather, at least one keratin protein isolated from human hair, and at least one carrier. The agricultural compositions provide an environmentally friendly and biodegradable alternative to traditional chemicals and biologicals. The agricultural compositions are suitable for a variety of uses including, but not limited to, increasing plant height and biomass, increasing plant, leaf, increasing stem and root weight, and increasing crop or plant yield compared to application of traditional chemicals or plant growth regulators.

### CROSS-REFERENCE TO RELATED APPLICATIONS

The present application claims priority to U.S. provisional application No. 63/459,801 filed Apr. 17, 2023.

### BACKGROUND OF THE DISCLOSURE

For millennia, man has endeavored to increase agricultural production and maintain the health of various plants and crops we depend upon for survival or otherwise enjoy for hobby. Today, agricultural and horticultural science has progressed to the point that optimal production is possible using far fewer resources than was previously required. Today, a variety of chemicals including significant amounts of chemical fertilizers may be required to obtain what is viewed as optimal plant health. Such chemicals are generally used for a wide variety of purposes including controlling weeds, retaining water, adding nutrients, and controlling pests such as insects, fungi and bacteria. Chemical fertilizers are usually suspended in liquid and can be added to the irrigation field systems or directly applied as pellets to the soil. Over time, these fertilizers can damage the soil, requiring additional amendments to stabilize the soil and maintain yield.

### SUMMARY OF THE DISCLOSURE

The present disclosure is directed to agricultural compositions that have the ability to replace traditional chemicals and deliver and all-natural and sustainable alternative without sacrificing results typically associated with traditional chemicals. The agricultural compositions provided herein include at least one keratin protein from at least one animal feather, at least one keratin protein from human hair, and at least one carrier. The agricultural compositions provided herein may optionally include moringa, feather meal, or a combination thereof. Thus, agricultural compositions provided herein are derived from sustainable components and, thus, provides an easy, fast and cost-efficient solutions to growing healthier plants and increasing agricultural production. The agricultural compositions are useful in a variety of settings including home gardening as well as large or small scale farms (i.e., traditional agriculture).

The agricultural compositions provided herein stimulate and increase healthy plant growth and improve or enhance the health and performance of agricultural, home and garden plants. The agricultural compositions provided herein are also useful to increase stem width, increase root length and increase final harvest weight. The agricultural compositions as provided herein are also suitable for promoting seed germination, promoting water retention, promoting spot growth on existing plantings, controlling weeds, and deterring pests.

According to one aspect, an agricultural composition is provided that includes at least one keratin protein from at least one feather and human that each, in turn, includes nitrogen, potassium, and phosphorus. According to one embodiment, the carrier includes water.

According to one aspect, an agricultural composition is provided that includes from about 0.5% v/v to about 5.0% v/v of the at least one keratin protein isolated from at least one feather; from about 0.5% v/v to about 5.0% w/w of the at least one keratin protein isolated from human hair; and the remainder at least one carrier, wherein the weight percentages are based on the total volume of the agricultural composition. According to one embodiment, the agricultural composition may optionally include from about 0.5% v/v to about 5.0% v/v moringa.

According to one aspect, an agricultural composition is provided that includes from about 0.5% v/v to about 5.0% v/v of the at least one keratin protein slurry prepared from at least one feather; from about 0.5% v/v to about 5.0% w/w of the at least one keratin protein slurry prepared from human hair; and the remainder at least one carrier, wherein the weight percentages are based on the total volume of the agricultural composition. According to one embodiment, the agricultural composition may optionally include from about 0.5% v/v to about 5.0% v/v moringa.

According to another aspect, an agricultural device is provided that includes an agricultural composition as provided herein as well as a multi-function horticultural device. According to one embodiment, the agricultural composition included in the agricultural device includes at least one animal feather, at least one keratin protein from human hair, moringa and at least one carrier. The multi-function horticultural device includes a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch. According to one embodiment, the multi-function horticultural device includes at least one natural fiber from the group including human hair, animal hair, coconut fiber, seaweed, kelp, cotton, corn silk and peat moss. According to one embodiment, the multi-function horticultural device further includes a plurality of man-made fibers.

According to one aspect, a method for stimulating root development of a plant is provided. The method includes the step of applying the agricultural composition as provided herein to a surface of the plant, surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch.

According to one aspect, a method of improving the quality or health of at least one target plant is provided. The method includes the step of applying the agricultural composition as provided herein to a surface of the at least one plant, the surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch.

According to one aspect, a method of increasing crop yield of at least one plant. The method includes the step of applying the agricultural composition as provided herein to the surface of the at least one plant, the surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch.

According to one aspect, a method of deterring pests from at least one plant is provided. The method includes the step of applying the agricultural composition as provided herein to the surface of the at least one plant, the surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch.

According to one aspect, a method of increasing moisture retention for at least one plant is provided. The method includes the step of applying the agricultural composition of as provided herein to the surface of the at least one plant, the surrounding soil, turf, seed, or a combination thereof. According to one embodiment, the method of further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch.

The summary of the disclosure is provided as a general introduction to some of the embodiments of the disclosure and is not intended to be limiting. Additional example embodiments including variations and alternative configurations of the disclosure are provided herein.

### DETAILED DESCRIPTION OF THE DISCLOSURE

One or more aspects and embodiments may be incorporated in a different embodiment although not specifically described. That is, all aspects and embodiments can be combined in any way or combination. When referring to the compounds disclosed herein, the following terms have the following meanings unless indicated otherwise. The following definitions are meant to clarify, but not limit, the terms defined. If a particular term used herein is not specifically defined, such term should not be considered indefinite. Rather, terms are used within their accepted meanings.

The use of “a” or “an” are employed to describe elements and components described herein. This is done merely for convenience and to give a general sense of the scope of the disclosure. This description should be read to include one or at least one and the singular also includes the plural unless it is obvious that it is meant otherwise.

As used herein, the terms “agriculture” and “agricultural” refer to the science, art, business or practice of farming and cultivation (both large and small scales) and further refers to horticulture which, in turn, includes the science, art, business or practice of growing plants used by people for various purposes included food, medicine or hobby.

As used herein, the term “agriculturally acceptable nutrients” refers to one or more of nitrogen, phosphorus, carbon, vanadium, chromium, cobalt, copper, zinc, selenium, strontium, cadmium, barium, arsenic, thallium, beryllium, silver, lead, nickel, manganese, calcium, iron, potassium, magnesium sodium, aluminum, molybdenum, titanium tin, antimony or mercury.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The term “effective amount,” as used herein, means an amount of an agricultural composition sufficient to attain the intended result.

As used herein, the term “feather” and “birth feather” refer to the actual flat appendage growing from avian (bird) skin (i.e., epidermal growth) and forming the bird's plumage. The feather may include a partly hollow shaft with vanes and barbs. The feathers provided herein may be harvested from any bird such as, for example, a chicken, duck, swan, goose, parrot, owl, stork, heron, crane woodpecker, flamingo, eagle, turkey, or pigeon. The feathers may be obtained as poultry feather waste from a variety of sources including slaughterhouses.

As used herein, the term “keratin protein(s)” as used herein collectively refers to one or more of: naturally occurring keratin, reduced keratin, oxidized keratin, S-sulfonated keratin, or a combination thereof that is each extracted from, derived from or otherwise isolated from at least one bird feather, human hair or a combination thereof. This term also refers to the extracted keratin protein derivatives that are produced by oxidative and/or reductive treatment of a keratin protein source. Types of keratin proteins, include but not limited to keratose, alpha-keratose, beta-keratose, gamma-keratose, kerateines, alpha-kerateine, beta-kerateine, or gamma-kerateine. Soluble keratin proteins can be extracted from keratin protein sources by oxidation or reduction using methods known in the art. If an oxidative treatment is used, the resulting keratin proteins are referred to as “keratoses.” If a reductive treatment is used, the resulting keratin proteins are referred to as “kerateines.”

The term “moringa” refers to moringa oleifera and includes moringa leaf extract derived from seeds, leaves, or a combination thereof. The moringa may be referred to as a drumstick tree, horseradish tree or ben oil tree.

“Optional” or “optionally” means that the subsequently described event or circumstance may or may not occur, and that the description includes instances where the event or circumstance occurs and instances where it does not.

### Overview

Agricultural compositions are provided that include at least one keratin protein derived from at least one bird feather. The keratin protein may be extracted from at least one feather may provide one or more nutrients or key elements for plants including, but not limited to, nitrogen, potassium, iron and phosphorus.

According to another embodiment, the agricultural compositions provided herein may include at least one keratin protein that is not separately extracted or otherwise removed from the feather. That is, according to such an embodiment, an entire bird feather may be utilized and otherwise processed for inclusion in the agricultural compositions such that the bird feather provides one or more nutrients or key elements for plants including, but not limited to, nitrogen, potassium, iron and phosphorus.

According to one embodiment, the agricultural compositions provided herein may include at least one keratin protein derived from human hair. The keratin protein may be extracted from human hair may provide one or more nutrients or key elements for plants including, but not limited to, nitrogen, potassium, iron and phosphorus.

According to one embodiment, the agricultural compositions provided herein may optionally include moringa, feather meal, or a combination thereof.

According to one embodiment, the agricultural compositions provided herein include at least one carrier. The carrier includes any biodegradable liquid that aids in the flowable or liquid nature of the final formulation and delivery of the same.

According to one embodiment, the agricultural compositions provided herein include, consist essentially of, or consist of at least one keratin protein from at least one animal feather, at least one keratin protein from human hair, and at least one carrier.

The agricultural compositions of the present disclosure provide an environmentally friendly and biodegradable alternative to traditional chemicals and biologicals. The agricultural compositions are suitable for a variety of uses including, but not limited to, increasing plant height and biomass, increasing plant, leaf, increasing stem and root weight, and increasing crop or plant yield compared to application of traditional chemicals or plant growth regulators. According to one embodiment, the agricultural compositions as provided herein are suitable for improving the number, size and quality of the crop grown from the plant, such as fruit, flowers, legumes or vegetables. According to one embodiment, the agricultural compositions as provided herein are suitable for promoting seed germination, promoting water retention, promoting spot growth on existing plantings, controlling weeds, and deterring pests. According to one embodiment, the agricultural compositions as provided herein may serve simultaneously as both an active and passive fertilizer as well as a herbicide. According to one embodiment, the agricultural compositions as provided herein may act as or contribute to a weed barrier. According to one embodiment, the agricultural compositions provide semi-slow release of one or more of nitrogen, potassium, phosphorus and iron over an extended period of time.

### Keratin Proteins

The agricultural compositions provided herein may include at least one keratin protein derived from at least one feather, human hair, or a combination thereof. The keratin protein is extracted from, derived from or otherwise isolated from at least one bird feather, human hair, or a combination thereof. According to one embodiment, the keratin protein from the feather and human hair is alpha-keratose, beta-keratose, gamma-keratose, alpha-kerateine, beta kerateine, gamma-kerateine, or a combination thereof. According to one embodiment, the keratin proteins as provided herein are substantially or completely soluble in water.

According to one embodiment, the agricultural compositions provided herein include at least one beta keratin protein derived from at least one feather, human hair, or a combination thereof. Alpha keratin proteins includes the keratin protein that is a large, spring-shaped protein. The alpha keratin protein may vary in peak average molecular weight (Mp) but typically falls in a range of from about 60 Da to about 6.2 MDa.

According to one embodiment, the keratin protein includes one or more elements suitable for agricultural use or needs. According to one embodiment, the keratin protein source provided herein includes nitrogen, phosphorus, potassium, carbon and other agriculturally acceptable nutrients in an effective amount. According to one embodiment, the keratin protein includes one or more elements such as, for example, nitrogen, phosphorus, potassium, calcium, magnesium, sulfur, boron, chlorine, iron, manganese, zinc, copper, molybdenum, or nickel.

According to one embodiment, the keratin protein derived from at least one feather or human hair includes at least about 0.01% w/w nitrogen based on the total weight of the feather or human hair. According to one embodiment, the keratin protein derived from at least one feather or human hair includes at least about 0.10% w/w, 0.5% w/w, 1.0% w/w/, 1.5% w/w, 2.0% w/w, 2.5% w/w, 5% w/w or more nitrogen. According to one embodiment, the keratin protein derived from at least one feather or human hair includes at least about 0.5% w/w to about 5.0% w/w nitrogen. According to one embodiment, the keratin protein derived from at least one feather or human hair includes at least about 5000 mg/L nitrogen based on the total volume of keratin protein (e.g., protein slurry). According to one embodiment, the keratin protein derived from at least one feather or human hair includes at least about 10000 mg/L, 15000 mg/L, 20000, mg/L or more nitrogen.

According to one embodiment, the keratin protein derived from at least one feather or human hair includes at least about 10 ppm phosphorus. According to one embodiment, the keratin protein derived from at least one feather or human hair includes at least about 20 ppm, 50 ppm, 75 ppm, 100 ppm, 200 ppm or more phosphorus. According to one embodiment, the keratin protein derived from at least one feather or human hair includes at least about 1.0 mg/L phosphorus. According to one embodiment, the keratin protein derived from at least one feather or human hair includes at least about 5 mg/L, 10 mg/L, 15 mg/L, 25 mg/L, 35 mg/L or more phosphorus based on the total volume of keratin protein (e.g., protein slurry).

According to one embodiment, the keratin protein derived from at least one feather or human hair includes at least about 0.01% w/w potassium. According to one embodiment, the keratin protein derived from at least one feather or human hair includes at least about 1000 ppm potassium. According to one embodiment, the keratin protein derived from at least one feather or human hair includes at least about 5000 ppm, 10000 ppm, 15000 ppm, 20000 ppm, 25000 ppm, 30000 ppm, 35000 ppm or more potassium.

### Moringa

Agricultural compositions are provided that may optionally include moringa. According to one embodiment, the agricultural composition includes at least about 0.1% w/w moringa based on the total weight of the agricultural composition. According to one embodiment, the agricultural composition includes up to about 0.5% w/w, 1.0% w/w, 1.5% w/w, 2% w/w/, 3% w/w, 4% w/w, 5.0% w/w, 10% w/w, 15% w/w, 20% w/w, 25% w/w, 30% w/w, 35% w/w, 40% w/w, 45% w/w, 50% w/w, 55% w/w, 60% w/w, 65% w/w, 70% w/w, 75% w/w, 80% w/w, 85% w/w, 90% w/w 95.0% w/w or more of the moringa.

According to one embodiment, the agricultural composition includes at least about 0.1% v/v of moringa based on the total volume of the agricultural composition. According to one embodiment, the agricultural composition includes up to about 1% v/v, 1.5% v/v, 2% v/v, 3% v/v, 4% v/v, 5% v/v or more of moringa. According to one embodiment, the agricultural composition includes about 0.5% v/v to about 2.5% v/v of moringa. According to one embodiment, the agricultural composition includes about 1.0% v/v to about 2.0% v/v of moringa.

According to one embodiment, the moringa provided herein includes nitrogen, phosphorus, carbon and other agriculturally acceptable nutrients in an effective amount. According to one embodiment, the moringa includes up to about 0.01% w/w nitrogen based on the total weight of the moringa. According to one embodiment, the moringa includes up to about 0.075% w/w nitrogen. According to one embodiment, the moringa includes up to about 0.05% w/w nitrogen. According to one embodiment, the moringa includes up to about 0.10% w/w nitrogen.

According to one embodiment, the moringa includes at least about 250 mg/L nitrogen based on total volume of the moringa (e.g., in a slurry). According to one embodiment, the moringa includes up to about 100 ppm, 150 ppm 200 ppm or more phosphorus. According to one embodiment, the moringa includes at least about 100 mg/L, 125 mg/L, or more phosphorus based on the total volume of the moringa. According to one embodiment, the moringa includes about 5000 mg/L potassium. According to one embodiment, the moringa includes about 2000 ppm potassium.

### Carrier and Additional Components

According to one embodiment, the agricultural compositions as provided herein include at least one carrier. The carrier includes any biodegradable liquid that aids in the flowable or liquid nature of the final formulation and delivery of the at least one keratin protein to a target destination. According to a particular embodiment, the carrier includes water. The water may be subject to reverse osmosis or deionized prior to use in the agricultural compositions as a carrier.

According to one embodiment, the agricultural compositions as provided herein may further include at least one additional component as provided herein. Particularly suitable additional components include, but are not limited to, any biodegradable compound that aids in the function of the keratin protein, provides nutrients, or stimulates microbial action in an agricultural setting. Suitable additional components include beneficial and biodegradable nutrients or microbes. Other suitable additional components include citric acid, potassium hydroxide, cocodimethylamine, polyoxyethylene sorbitan monolaurate (commercially available as Tween™ 21), at least one emulsifier compound, at least one antifoaming compound, at least one antimicrobial agent, at least one buffer, at least one corrosion inhibitor, at least one dispersing agent, at least one dye, at least one fragrant, at least one freezing point depressant, at least one neutralizing agent, at least one odorant, at least one penetration aid, at least one sequestering agent, at least one spray drift control agent, at least one spreading agent, at least one stabilizer, at least one sticking agent, at least one viscosity-modifying additive, at least one preservative, at least one plasticizer, at least one hydrophobic barrier, at least one UV protectant, at least one water soluble solvent, or any combination thereof.

### Agricultural Compositions

The percentage weight (% w/w) of at least one keratin protein in the agricultural compositions derived from at least one feather, human hair, or a combination thereof may vary and is based on the total weight of the agricultural composition. According to one embodiment, the agricultural composition includes at least about 0.1% w/w, 0.5% w/w, 1.0% w/w, 2.0% w/w, 3.0% w/w, 4.0% w/w, 5.0% w/w, 6.0% w/w, 7.0% w/w, 8.0% w/w, 9.0%, 10.0% w/w, 11.0% w/w, 12.0% w/w, 13.0% w/w, 14.0% w/w, 15.0% w/w, 16.0% w/w, 17.0% w/w, 18.0% w/w, 19.0% w/w, 20.0% w/w, 21.0% w/w, 22.0% w/w, 23.0% w/w, 24.0% w/w, 25.0% w/w, or more of at least one keratin protein derived from at least one feather, human hair, or a combination thereof.

The percentage volume (% v/v) of at least one keratin protein in the agricultural compositions derived from at least one feather, human hair, or a combination thereof may vary and is based on the total volume of the agricultural composition. According to one embodiment, the agricultural composition includes at least about 0.1% v/v to about 40.0% v/v of at least one keratin protein derived from at least one feather, human hair, or a combination thereof. According to one embodiment, the agricultural composition includes at least about 0.5% v/v to about 10.0% v/v of at least one keratin protein derived from at least one feather, human hair, or a combination thereof. According to one embodiment, the agricultural composition includes at least about 0.75% v/v to about 7.5% v/v of at least one keratin protein derived from at least one feather, human hair, or a combination thereof. According to one embodiment, the agricultural composition includes at least about 1.0% v/v to about 4.0% v/v of at least one keratin protein derived from at least one feather, human hair, or a combination thereof.

According to one embodiment, the agricultural composition includes at least about 0.1% v/v to about 40.0% v/v of at least one keratin protein slurry prepared from at least one feather, human hair, or a combination thereof. According to one embodiment, the agricultural composition includes at least about 0.5% v/v to about 10.0% v/v of at least one keratin protein slurry prepared from at least one feather, human hair, or a combination thereof. According to one embodiment, the agricultural composition includes at least about 0.75% v/v to about 7.5% v/v of at least one keratin protein slurry prepared from at least one feather, human hair, or a combination thereof. According to one embodiment, the agricultural composition includes at least about 1.0% v/v to about 4.0% v/v of at least one keratin protein slurry prepared from at least one feather, human hair, or a combination thereof.

According to a particular embodiment, the agricultural composition includes from about 0.1% v/v to about 5% v/v of at least one keratin protein derived from at least one feather and about 0.1% v/v to about 5% v/v of at least one keratin protein derived from human hair. According to a particular embodiment, the agricultural composition includes from about 0.1% v/v to about 5% v/v of at least one keratin protein derived from at least one feather, about 0.1% v/v to about 5% v/v of at least one keratin protein derived from human hair and about 0.1% v/v to about 5% v/v of moringa, feather meal or a combination thereof.

According to a particular embodiment, the agricultural composition includes from about 0.1% v/v to about 5% v/v of at least one keratin protein slurry prepared from at least one feather and about 0.1% v/v to about 5% v/v of at least one keratin protein slurry prepared from human hair. According to a particular embodiment, the agricultural composition includes from about 0.1% v/v to about 5% v/v of at least one keratin protein slurry prepared from at least one feather, about 0.1% v/v to about 5% v/v of at least one keratin protein slurry prepared from human hair and about 0.1% v/v to about 5% v/v of moringa, feather meal or a combination thereof.

According to a particular embodiment, the agricultural composition includes from about 0.5% v/v to about 4.0% v/v of at least one keratin protein derived from at least one feather and about 0.5% v/v to about 4.0% v/v of at least one keratin protein derived from human hair. According to a particular embodiment, the agricultural composition includes from about 0.5% v/v to about 4.0% v/v of at least one keratin protein derived from at least one feather, about 0.5% v/v to about 4.0% v/v of at least one keratin protein derived from human hair and about 0.5% v/v to about 4.0% v/v of moringa, feather meal or a combination thereof.

According to a particular embodiment, the agricultural composition includes from about 0.5% v/v to about 4.0% v/v of at least one keratin protein slurry prepared from at least one feather and about 0.5% v/v to about 4.0% v/v of at least one keratin protein slurry prepared from human hair. According to a particular embodiment, the agricultural composition includes from about 0.5% v/v to about 4.0% v/v of at least one keratin protein slurry prepared from at least one feather, about 0.5% v/v to about 4.0% v/v of at least one keratin protein slurry prepared from human hair and about 0.5% v/v to about 4.0% v/v of moringa, feather meal or a combination thereof.

According to a particular embodiment, the agricultural composition includes from about 1.0% v/v to about 4.0% v/v of at least one keratin protein derived from at least one feather and about 1.0% v/v to about 4.0% v/v of at least one keratin protein derived from human hair. According to a particular embodiment, the agricultural composition includes from about 1.0% v/v to about 4.0% v/v of at least one keratin protein derived from at least one feather, about 1.0% v/v to about 4.0% v/v of at least one keratin protein derived from human hair and about 1.0% v/v to about 4.0% v/v of moringa, feather meal or a combination thereof.

According to a particular embodiment, the agricultural composition includes from about 1.0% v/v to about 4.0% v/v of at least one keratin protein slurry prepared from at least one feather and about 1.0% v/v to about 4.0% v/v of at least one keratin protein slurry prepared from human hair. According to a particular embodiment, the agricultural composition includes from about 1.0% v/v to about 4.0% v/v of at least one keratin protein slurry prepared from at least one feather, about 1.0% v/v to about 4.0% v/v of at least one keratin protein slurry prepared from human hair and about 1.0% v/v to about 4.0% v/v of moringa, feather meal or a combination thereof.

According to a particular embodiment, the agricultural composition includes from about 1.0% v/v, 1.1% v/v, 1.2% v/v 1.3% v/v, 1.4% v/v, or 1.5% v/v to about 4.0% v/v of at least one keratin protein derived from at least one feather and about 1.0% v/v, 1.1% v/v, 1.2% v/v 1.3% v/v, 1.4% v/v, or 1.5% v/v to about 4.0% v/v of at least one keratin protein derived from human hair.

According to a particular embodiment, the agricultural composition includes from about 1.0% v/v, 1.1% v/v, 1.2% v/v 1.3% v/v, 1.4% v/v, or 1.5% v/v to about 4.0% v/v of at least one keratin protein slurry prepared from at least one feather and about 1.0% v/v, 1.1% v/v, 1.2% v/v 1.3% v/v, 1.4% v/v, or 1.5% v/v to about 4.0% v/v of at least one keratin protein slurry prepared from human hair.

### Agricultural Composition Formulations

According to one embodiment, the agricultural compositions as provided herein are formulated as a flowable composition. According to one embodiment, the agricultural compositions as provided herein are formulated as a liquid. According to one embodiment, the agricultural compositions as provided herein are formulated as a slurry.

According to one embodiment, the agricultural compositions as provided herein are formulated as ready-to-use formulation. The ready-to-use formulation may be immediately used as described herein without any mixing or dilution. The ready-to-use formulation may include the percentage volumes of keratin protein and moringa as provided herein with the remainder a suitable carrier such as water. According to a particular embodiment, the ready-to-use formulation includes an agricultural composition that includes from about 1.0% v/v to about 4.0% v/v of at least one keratin protein derived from at least one feather, about 1.0% v/v to about 4.0% v/v of at least one keratin protein derived from human hair, optionally about 1.0% v/v to about 4.0% v/v of moringa, and the remainder a suitable carrier such as water. The ready-to-use formulation may be stored in a delivery device such as a spray bottle until use. The ready-to-use formulation is particularly suitable for indoor or decorative plants and trees as well as outdoor individual plants and trees.

According to one embodiment, the agricultural compositions as provided herein are formulated as an concentrate. The concentrate formulation may include a feather-based keratin protein slurry, a human hair-based keratin protein slurry and moringa. The concentrate formulation may be mixed with or otherwise diluted with water, spray oil, or a combination thereof at the time of use.

According to one embodiment, the agricultural compositions as provided herein may also be formulated as an emulsifiable concentrate formulation, aqueous suspension concentrate (suspension concentrate), emulsion in water formulation, oil dispersion, or concentrated aqueous solution.

According to one embodiment, the agricultural compositions provided herein may be mixed with, soaked/introduced in or otherwise used in conjunction with a multi-function horticultural device to form an agricultural device as described herein.

### Methods of Production

A method of producing an agricultural composition is provided. According to one embodiment, the method includes the step of providing a keratin protein source including at least one bird feather, human hair, or a combination thereof. According to one embodiment, the method includes the step of washing the keratin protein source. The step of washing may include applying water to the keratin protein source. The water may be provided via reverse osmosis or may be deionized water. The ratio of keratin source to water is about 5 parts keratin source (e.g., feather or human hair) to 95 parts water). The step of washing may include agitating the keratin source in the presence of water.

For a keratin source derived from at least one feather, the method of producing an agricultural composition includes the step of extracting or lifting the keratin source cuticle thereby enabling release of one or more keratin proteins.

The step of extracting or lifting the keratin protein from feather or hair may be accomplished by oxidation or reduction reactions of the keratin source by which the crosslinked structure of keratin source is broken down. According to one embodiment, the disulfide bonds in cysteine amino acid residues are cleaved, rendering one or more keratin proteins within the keratin source soluble.

According to one embodiment, the one or more keratin proteins trapped in the feather (e.g., inside the cuticle's protective structure of hair) and hair may be released by oxidatively reacting a denaturing solution with the keratin protein source to form an acid mixture. Suitable denaturing solutions include urea, transition metal hydroxides, surfactant solutions, and combinations thereof. Common methods utilize aqueous solutions of tris base (2-Amino-2-(hydroxymethyl)-1,3-propanediol) in concentrations between 0.1 and 1.0 M, and urea solutions between 0.1 and 10M. According to one embodiment, the denaturing solution may be peracetic acid that is present at a concentration of from about 0.1M to about 0.15M.

According to one embodiment, the method of producing an agricultural composition includes the step of heating the acid mixture to about 40° C. to 45° C. to form a heated acid mixture. According to one embodiment, the method of producing an agricultural composition includes the step of incubating the heated acid mixture for about 15 hours to about 18 hours to form an incubated acid mixture. According to one embodiment, the method of producing an agricultural composition includes the step of removing the peracetic acid from the incubated acid mixture to form an oxidized keratin source based slurry. The peracetic acid may be removed by rinsing the keratin source slurry with water.

According to one embodiment, the method of producing an agricultural composition includes the step of treating the oxidized keratin source with 0.1M-0.15M tris(hydroxymethyl)aminomethane to form a disassociated keratin protein. According to one embodiment, the method of producing an agricultural composition includes the step of incubating the disassociated keratin protein at about 40° C. to 45° C. for about 2 hours to about 4 hours to form a keratin protein slurry. According to one embodiment, the method of producing an agricultural composition includes the step of introducing moringa to the keratin slurry described herein. According to one embodiment, the method of producing an agricultural composition includes the step of mixing water and, optionally, moringa with the keratin protein slurry to form an agricultural composition.

According to another embodiment, the method of producing an agricultural composition includes one or more steps to prepare a feather meal. The feather meal may be formed by hydrolyzing one or more feathers under elevated heat and pressure. According to one embodiment, the step of hydrolyzing may include heating (e.g., via steam) one or more bird feathers at 90° C. to 180° C. for at least about five hours under elevated pressure of 200 kPa to about 400 kPa. According to one embodiment, the step of hydrolyzing may include acid hydrolysis via hydrochloric acid or sulfuric acid. According to one embodiment, the step of hydrolyzing may include alkaline hydrolysis via sodium hydroxide, sodium sulfide or calcium hydroxide. According to one embodiment, the step of hydrolyzing may include digesting the one or more feathers in one or more enzymes or bacteria such as Bacillus subtilis, Bacillus flexus, Bacillus endophyticus, fungal keratinase, alkaline protease, or a combination thereof. According to one embodiment, the method of producing an agricultural composition includes the step of mixing water with the feather meal to form an agricultural composition.

### Methods of Application

According to one embodiment, the agricultural compositions provided herein may be applied to plant soil. According to one embodiment, the agricultural compositions provided herein may be applied below the soil surface or on top of the soil surface. According to one embodiment, the agricultural compositions provided herein may be mixed with a growth medium such as top soil or potting soil.

According to one embodiment, the agricultural compositions provided herein may be applied to an exposed plant surface. According to one embodiment, the agricultural compositions provided herein may be applied to a plant root. According to one embodiment, the agricultural compositions provided herein may be applied at or near a plant root.

According to one embodiment, the agricultural compositions as provided herein may be added to a spray tank such that a stable tank mix composition is formed when the agricultural composition and any other additional optional ingredients, such as water or spray oil, are combined in the spray tank. The tank mix composition may be applied directly to a target plant or pest. The tank mix agricultural composition is particularly suited for direct application to at least one crop plant, the surrounding soil, turf, seed, or a combination thereof. According to one embodiment, the tank mix agricultural compositions as provided herein may be applied via a sprayer attached to a tank.

According to one embodiment, the agricultural compositions as provided herein may be applied via an irrigation system (chemigation). According to one embodiment, the agricultural compositions as provided herein may be applied as a drench treatment. According to one embodiment, the agricultural compositions as provided herein may be applied as a wick system.

According to a particular embodiment, the agricultural composition is applied at an effective rate of typically about 1.0 gallon per acre. According to a particular embodiment, the agricultural composition is applied at an effective rate of typically about 2.0 gallons per acre. According to a particular embodiment, the agricultural composition is applied at an effective rate of typically about 3.0 gallons per acre. According to a particular embodiment, the agricultural composition is applied at an effective rate of typically about 4.0 gallons per acre. According to a particular embodiment, the agricultural composition is applied at an effective rate of typically about 5.0 gallons per acre.

According to a particular embodiment, the agricultural composition is applied at an effective rate of typically about 1.0 gallon per acre to about 10.0 gallons per acre. According to a particular embodiment, the agricultural composition is applied at an effective rate of typically about 2.0 gallons per acre to about 9.0 gallons per acre. According to a particular embodiment, the agricultural composition is applied at an effective rate of typically about 3.0 gallons per acre to about 7.0 gallons per acre. According to a particular embodiment, the agricultural composition is applied at an effective rate of typically about 4.0 gallons per acre to about 8.0 gallons per acre.

According to one embodiment, the agricultural compositions provided here may be applied at a rate of from about 0.1 milliliter per plant to about 10 milliliter per plant, per treatment when applied to a plant surface (leaves, stems, etc.).

### Agricultural Device

According to one embodiment, the agricultural compositions provided herein may be formulated as a liquid or flowable and mixed with, soaked/introduced in or otherwise used in conjunction with a multi-function horticultural device to form an agricultural device. The multi-function horticultural device includes the device as set forth in U.S. Pat. No. 8,281,516, the contents of which are incorporated herein by reference in its entirety. The multi-function horticultural device includes a plurality of individual natural fibers intertwined such that the device has a density from generally about 0.02 to generally about 3 grams of individual natural fibers per cubic inch. The device is capable of holding and retaining from generally about 0.02 to generally about 15 grams of liquid or agricultural composition per cubic inch. According to one embodiment, the agricultural device may be generally homogeneous.

According to one embodiment, the multi-function horticultural device portion of the agricultural device includes at least one natural fiber from the group including human hair, animal hair, coconut fiber, seaweed, kelp, cotton, corn silk and peat moss. According to one embodiment, the plurality of individual natural fibers are intertwined by needle punching. According to one embodiment, the multi-function horticultural device is formed into a shape from the group including a generally rectangular planar mat, a generally rectangular solid, a disk, and a generally circular cylinder, depending on its intended usage. According to one embodiment, the multi-function horticultural device further includes a plurality of man-made fibers. According to one embodiment, the plurality of individual natural fibers may be formed into any pre-defined three-dimensional shape, intertwined by hydro-entangling, or formed into any pre-defined three-dimensional shape such as a rectangle, disk, or circular cylinder. According to one embodiment, the accumulation of natural fibers are intertwined using aero-entanglement. According to one embodiment, the plurality of individual natural fibers may be formed into any pre-defined three-dimensional shape.

According to one embodiment, the agricultural device is capable of both passively and actively fertilizing a plant with which it is associated and wherein such passive fertilization is the result of the device's biodegradation and microbial action. According to one embodiment, the agricultural device serves to reduce the growth and propagation of weeds in ground covered with the device. According to one embodiment, the agricultural device serves to inhibit the activity of pests from the general area of a plant with which the device is associated. According to one embodiment, the agricultural device serves to reduce the watering needs of a planting with which it is associated through its moisture retention capability. According to one embodiment, the agricultural device

According to one embodiment, an agricultural composition as provided herein may be applied to a soil surface, applied below a soil surface or mixed with soil surrounding a plant prior to application of the multi-function horticultural device over the soil surface containing the agricultural composition.

### Methods of Use

The agricultural compositions provided herein stimulate and increase healthy plant growth and improve or enhance the health and performance of plants. Such plants include agricultural, home and garden plants. By improving the health and performance of plants, the resulting flowers, fruits, vegetable, legumes or similar target growth items may appear at an accelerated pace, appear healthier (e.g., higher quality plant) and have increased yield. According to one embodiment, the agricultural compositions provided herein stimulate and otherwise increase plant growth or plant height by at least about 1%, 5%, 10%, 15%, 20%, 25% or more. According to one embodiment, the agricultural compositions provided herein stimulate and otherwise increase crop yield by at least about 1%, 5%, 10%, 15%, 20%, 25%, 30%, 35%, 40%, 45%, 50%, 55%, 60%, 65%, 70%, 75%, 80%, 85%, 90%, 95%, or more.

The agricultural compositions provided herein stimulate stem diameter, stimulate root length and increase final harvest plant weight. Stem and root length contributes to improved and more efficient water utilization as well as overall robustness and vigor of the plant. According to one embodiment, the agricultural compositions provided herein increase stem diameter by at least about 1%, 5%, 10%, 15%, 25%, 35%, 45%, 50% or more. According to one embodiment, the agricultural compositions provided herein increase plant weight by at least about 1%, 5%, 10%, 15%, 20%, 25%, 35%, 40%, 45%, 50%, 55%, 60%, 65%, 70%, 75%, 80%, 85%, 90%, 95% or more. According to one embodiment, the agricultural compositions provided herein increase plant root length by at least about 1%, 5%, 10%, 15%, 20%, 25%, 30%, 35%, 40%, 45% or more.

The agricultural compositions as provided herein are suitable for promoting seed germination. According to such an embodiment, the agricultural compositions may be introduced to a seed prior to or at the point of planting.

The agricultural compositions as provided herein are suitable for promoting spot growth on existing plantings. According to such an embodiment, the agricultural compositions may be introduced to a plant locus.

The agricultural compositions as provided herein are suitable for deterring pests. According to such an embodiment, the agricultural compositions may be introduced to a plant locus or surrounding soil after planting. Pests subject to determent include, but are not limited to, any animal that is deemed detrimental to plant health. Such pests include mammals (deer, rabbit, raccoon, squirrel, or boar/pig), reptiles, or insects.

The agricultural compositions as provided herein may serve simultaneously as both an active and passive fertilizer as well as a herbicide. According to such an embodiment, the agricultural compositions may slowly release any nutrients into the soil surrounding a plant thereby providing both active and passive fertilization to a target plant.

The agricultural compositions as provided herein may act as or contribute to a natural weed barrier as well as provide a means of weed control (e.g., preventing weed growth). According to such an embodiment, the agricultural compositions may be introduced to the soil surrounding a plant.

A method for stimulating root development of a plant is provided that includes the step of applying an agricultural composition to a surface of the plant, surrounding soil, turf, seed, or a combination thereof, the agricultural composition including at least one keratin protein isolated from at least one feather; at least one keratin protein isolated from human hair; and at least one carrier, wherein upon application, root development is stimulated. According to one embodiment, the method further includes the step of introducing a multi-function horticultural device to the surrounding soil that includes the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch. According to one embodiment, upon application to the surface of a plant, the plant growth is increased by at least about 5% compared to an plant that is not subject to application of the agricultural composition. According to one embodiment, each of the at least one keratin protein isolated from at least one feather and at least one keratin protein isolated from human hair are formulated as a slurry.

A method of improving the quality or health of at least one target plant is provided that includes the step of applying an agricultural composition to a surface of the plant, surrounding soil, turf, seed, or a combination thereof, the agricultural composition including at least one keratin protein isolated from at least one feather; at least one keratin protein isolated from human hair; and at least one carrier, wherein upon application, the quality or health of the at least one target plant is improved. According to one embodiment, the method further includes the step of introducing a multi-function horticultural device to the surrounding soil that includes the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch. According to one embodiment, upon application to the surface of a plant, the plant growth is increased by at least about 5% compared to an plant that is not subject to application of the agricultural composition. According to one embodiment, each of the at least one keratin protein isolated from at least one feather and at least one keratin protein isolated from human hair are formulated as a slurry.

A method of increasing crop yield of at least one plant is provided that includes the step of applying an agricultural composition to a surface of the plant, surrounding soil, turf, seed, or a combination thereof, the agricultural composition including at least one keratin protein isolated from at least one feather; at least one keratin protein isolated from human hair; and at least one carrier, wherein upon application, crop yield is increased. According to one embodiment, the method further includes the step of introducing a multi-function horticultural device to the surrounding soil that includes the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch. According to one embodiment, upon application to the surface of a plant, the plant growth is increased by at least about 5% compared to an plant that is not subject to application of the agricultural composition. According to one embodiment, each of the at least one keratin protein isolated from at least one feather and at least one keratin protein isolated from human hair are formulated as a slurry.

A method of deterring pests from at least one plant is provided that includes the step of applying an agricultural composition to a surface of the plant, surrounding soil, turf, seed, or a combination thereof, the agricultural composition including at least one keratin protein isolated from at least one feather; at least one keratin protein isolated from human hair; and at least one carrier, wherein upon application, one or more pests are deterred. According to one embodiment, the method further includes the step of introducing a multi-function horticultural device to the surrounding soil that includes the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch. According to one embodiment, upon application to the surface of a plant, the plant growth is increased by at least about 5% compared to an plant that is not subject to application of the agricultural composition. According to one embodiment, each of the at least one keratin protein isolated from at least one feather and at least one keratin protein isolated from human hair are formulated as a slurry.

A method of increasing moisture retention for at least one plant is provided that includes the step of applying an agricultural composition to a surface of the plant, surrounding soil, turf, seed, or a combination thereof, the agricultural composition including at least one keratin protein isolated from at least one feather; at least one keratin protein isolated from human hair; and at least one carrier, wherein upon application, moisture retention is increased. According to one embodiment, the method further includes the step of introducing a multi-function horticultural device to the surrounding soil that includes the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch. According to one embodiment, upon application to the surface of a plant, the plant growth is increased by at least about 5% compared to an plant that is not subject to application of the agricultural composition. According to one embodiment, each of the at least one keratin protein isolated from at least one feather and at least one keratin protein isolated from human hair are formulated as a slurry.

### EXAMPLES

### Experimental Setup for Examples

Testing plots of cabbage, basil, and corn were utilized for testing on a farm in Sharp's Cove, Alabama USA. The plots were planted in a heavy Tennessee valley red clay, turned, double tilled and hand raked.

The agricultural compositions tested are set forth below in Table 1. The control plot was not treated with any agricultural composition and, instead, included Miracle-Gro® Soil for In-Ground Use that included 0.09% total nitrogen, 0.05% phosphate (P₂O₅), and 0.07% potassium (K₂O) as well as the integral organic amendment of 0.5 cubic foot per linear foot of plant row.

The application rate (i.e., eight (8) fine mist sprays via a hand-held applicator) was 1.0 teaspoon of agricultural composition (approximately 5 milliliters) per plant.

TABLE 1

| Test Plot Designation | Agricultural Composition Applied |
|---|---|
| HE Plot | 1.25% v/v keratin (human hair) |
| ME Plot | 1.25% v/v moringa |
| FE Plot | 1.25% v/v keratin (feather) |
| Combination Plot | 2% v/v keratin (human hair) |
| | 2% v/v keratin (feather) |
| | 2% v/v moringa |
| Half Combination | 1% v/v keratin (human hair) |
| Plot | 1% v/v keratin (feather) |
| | 1% v/v moringa |

### Example 1

### Corn

The corn tested was obtained from DeKalb/Bayer crop Science, St. Louis, Missouri (Roundup Ready® Corn 2, W/Accelleron® seed treatment). The corn seed was soaked in water for 8 hours as pre-germination treatment. The seeds were planted 10″ on center.

The corn plants were allowed to germinate and grow to three inches tall prior to entering a treatment (spray) schedule. Specifically, all corn plants were treated with eight (8) fine mist sprays via a hand-held applicator after reaching three inches tall. Treatment with eight (8) fine mist sprays via a hand-held applicator was carried out at again at two (2) weeks, four (4) weeks, six (6) weeks and eight (8) weeks for a total of five (5) treatments over a total of eight (8) weeks. Occasional applications of bT organic caterpillar insecticide were needed to keep down predation of cutworms, corn borers, cabbage butterfly caterpillars and other lepidoptera species. An electrified fence was installed to keep down deer predation.

There was a drought during production with only one rain of 0.75 inches recorded during the test. Hand watering of plants was necessary two to three times a week, with the addition of pine straw mulch needed to reduce evaporation and drying of the soil.

The total growth height (inches) after eight weeks for each plot is provided in Table 2. In summary, all agricultural compositions, except for the 1.25% moringa-only composition, outperformed the control plot.

TABLE 2
Corn Testing Results After Eight Weeks (inches growth)

| Plant | HE | Full Comb | FE | Half Combo | Control | ME |
|---|---|---|---|---|---|---|
| No. | Plot | Plot | Plot | Plot | Plot | Plot |
| 1 | 80.7 | 108.3 | 104.3 | 86.5 | 100.2 | 60.8 |
| 2 | 88.2 | 58.4 | 96.2 | 86.8 | 112.9 | 73.2 |
| 3 | 92.9 | 106.9 | 106.5 | 101.3 | 78.4 | 68.1 |
| 4 | 87.9 | 89.5 | 65.9 | 91.8 | 55.8 | 80.2 |
| 5 | 89.3 | 103.2 | 68.4 | 78.9 | 76.5 | 72.1 |
| Total | 439 | 466.3 | 441.3 | 445.3 | 423.8 | 354.4 |
| Average | 87.80 | 93.26 | 88.26 | 89.06 | 84.76 | 70.88 |

### Example 2

### Cabbage

Cabbage tested was obtained from Bonnie Plant Farm (Variety-Bonnie Hybrid), Union Springs, Alabama. The cabbage plants were planted as plugs from 606 packs and planted 18″ on center.

The cabbage was double hand watered in on the day of planting. A deer fence was erected to provide browse protection. Some stress showed on the cabbage on the first day.

The following day after planting, the cabbage plants were treated with the compositions set forth in Table 1. Treatment was carried out by spraying the plants with eight (8) fine mist sprays via a hand-held applicator and repeated again at two (2) weeks, four (4) weeks, six (6) weeks and eight (8) weeks for a total of five (5) treatments over a total of eight (8) weeks.

During the first two weeks, no real difference in plant growth for was observed across all plots. In the following two weeks, as the number of new leaves increased following a second treatment, there was an increase in the number and size of the leaves of all plants treated with an agricultural composition.

By the end of the second two-week period and time to apply a third treatment, the leaves of the combination plot, half combination plot, HE plot and FE plot all exhibited leaf sizes that were as good or better than the control plot.

By the end of five (5) weeks, the FE plot exhibited visibly healthier and more robust plants compared to all other plots. The FE plot, HE plot, combination plot and half combination plot all exhibited similar plant growth.

At the five week point, the HE plot, combination plot and half combination plot exhibited visibly equal health and robustness with the control plot. Such an observation was unexpected as there was no fertilizer applied to the soil or plants subject to the test agricultural compositions while the control plot had both fertilizer and a good level of organic soil amendment added. All agricultural compositions resulted in accelerated growth of leaf size and number compared to the control, and such observations appeared to increase as the cabbage plants got larger.

In the last two weeks of testing, the control plot cabbage plants visually started to catch up with the cabbage plants treated with an agricultural composition, which is not surprising considering the superior root zone and fertilizer level made available via the control plot soil. The combination plot plants out produced cabbage compared to the control plot cabbage plants based on actual weight produced when finally weighed. In fact, with the exception of the ME plot, all agricultural compositions statistically equaled or exceeded cabbage weight compared to the control plot.

As to the palatability of the cabbage produced, all cabbage were sweet and of low bitterness, however, the cabbage treated with each of the agricultural compositions provided exceptional sweet taste compared to the cabbage of the control plot.

### Example 3

### Basil

Basil tested was Genovese basil obtained from Bonnie Plant Farm, Union Springs, Alabama. The basil plants were 3-4 inches tall and planted 18″ on center. The basil plants were from 4.5″ cups that were seeded with Genovese basil.

The basil was double hand watered in on the day of planting. A deer fence was erected to provide browse protection. The following day after planting, the basil plants were treated with the compositions set forth in Table 1. Treatment was carried out by spraying the plants with eight (8) fine mist sprays via a hand-held applicator and repeated again at two (2) weeks, four (4) weeks, six (6) weeks and eight (8) weeks for a total of five (5) treatments over a total of eight (8) weeks.

At the end of eight (8) weeks, the control plot plants were observed to be fairly full and had two flowering plants. The control (MG) plot basil plants were observed to be stocky, 10-12 inches in height, and had three flowering basil plants. The combination plot basil plants were observed to be very stocky, full, 10-12 inches in height, and had six flowering basil plants. All combination plot basil plants were healthy. The half combination plot basil plants were stocky, 8-10 inches in height, and had one plant flowering basil plant.

The FE plot plants were observed to be stocky, full plants that were 10-12 inches tall but not wide and had two flowering basil plants. The HE plot plants were observed to be stocky, full plants that were 10 inches tall, and had three flowering basil plants. The ME plot plants were stocky, full plants that were 8 inches tall, and had two flowering basil plants.

### Example 4

### Tomato

Big Boy and Park's Whopper tomato plants from Bonnie Plant Farm were treated once with the agricultural compositions set forth in Table 1 by spraying the plants with eight (8) fine mist sprays via a hand-held applicator. One week after treatment, all tomato plants were observed to be one inch or more taller and more robust. This trend was also observed two weeks after treatment.

Although specific embodiments of the present invention are herein illustrated and described in detail, the invention is not limited thereto. The above detailed descriptions are provided as exemplary of the present invention and should not be construed as constituting any limitation of the invention. Modifications will be apparent to those skilled in the art, and all modifications that do not depart from the spirit of the invention are intended to be included with the scope of the appended claims.

### General Statements

The following statements provide a general description of the disclosure and are not intended to limit the appended claims.

Statement 1. An agricultural composition is provided that includes at least one feather or at least one keratin protein isolated from at least one feather, at least one keratin protein isolated from human hair, moringa, and at least one carrier.

Statement 2. An agricultural composition is provided according to Statement 1, wherein the at least one feather and human hair each comprise a total nitrogen content of from about 0.5% w/w to about 5.0% w/w.

Statement 3. An agricultural composition is provided according to Statements 1-2, wherein the at least one feather and human hair each comprises at least 1.0% w/w nitrogen.

Statement 4. An agricultural composition is provided according to Statements 1-3, wherein the carrier comprises water.

Statement 5. An agricultural composition is provided according to Statements 1-4, comprising: from about 0.5% v/v to about 5.0% v/v of the at least one keratin protein isolated from or slurry prepared from at least one feather; from about 0.5% v/v to about 5.0% v/v of the at least one keratin protein isolated from or slurry prepared from human hair; optionally from about 0.5% v/v to about 5.0% v/v moringa; and the remainder at least one carrier, wherein the weight percentages are based on the weight of the total agricultural composition.

Statement 6. An agricultural composition is provided according to Statements 1-5, wherein the at least one bird feather and human hair each include from about from about 0.5% w/w to about 5.0% w/w.

Statement 7. An agricultural composition is provided according to Statements 1-6, wherein upon application to a plant, the plant growth or plant height is increased by at least about 5%, 10%, 15%, 20%, 25% or more compared to an plant that is not subject to application of the composition.

Statement 8. An agricultural composition is provided according to Statements 1-6, wherein upon application to a plant, the stem diameter is increased by at least about 15%, 25%, 35%, 45%, 50% or more compared to an plant that is not subject to application of the composition.

Statement 9. An agricultural composition is provided according to Statements 1-6, wherein upon application to a plant, the plant weight is increased by at least about 1%, 5%, 10%, 15%, 20%, 25% or more compared to an plant that is not subject to application of the composition.

Statement 10. An agricultural composition is provided according to Statements 1-6, wherein upon application to a plant, the plant roots are increased by at least about 1%, 5%, 10%, 15%, 20%, 25%, 30%, 35%, 40%, 45% or more compared to an plant that is not subject to application of the composition.

Statement 11. An agricultural device is provided that includes an agricultural composition of Statements 1-6 and a multi-function horticultural device including plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of agricultural composition per cubic inch.

Statement 12. An agricultural device is provided according to Statement 11, wherein the multi-function horticultural device includes at least one natural fiber from the group including human hair, animal hair, coconut fiber, seaweed, kelp, cotton, corn silk and peat moss.

Statement 13. An agricultural device is provided according to Statements 11-12, wherein the multi-function horticultural device includes a plurality of individual natural fibers that may be intertwined by needle punching.

Statement 14. An agricultural device is provided according to Statements 11-13, wherein the multi-function horticultural device is formed into a shape from the group including a generally rectangular planar mat, a generally rectangular solid, a disk, and a generally circular cylinder, depending on its intended usage.

Statement 15. An agricultural device is provided according to Statements 11-14, wherein the multi-function horticultural device further comprises a plurality of man-made fibers.

Statement 16. An agricultural device is provided according to Statements 11-15, wherein the multi-function horticultural device includes a plurality of individual natural fibers that may be formed into any pre-defined three-dimensional shape.

Statement 17. An agricultural device is provided according to Statements 11-16, wherein the multi-function horticultural device includes a plurality of individual natural fibers that may be intertwined by hydro-entangling.

Statement 18. An agricultural device is provided according to Statements 11-17, wherein the multi-function horticultural device is formed into a shape from the group including a generally rectangular planar mat, a generally rectangular solid, a disk, and a generally circular cylinder, depending on its intended usage.

Statement 19. An agricultural device is provided according to Statements 11-18, wherein the accumulation of natural fibers are intertwined using aero-entanglement.

Statement 20. An agricultural device is provided according to Statements 11-19, wherein the device is capable of both passively and actively fertilizing a plant with which it is associated and wherein such passive fertilization is the result of the device's biodegradation and microbial action.

Statement 21. An agricultural device is provided according to Statements 11-20, wherein the device serves to reduce the growth and propagation of weeds in ground covered with the device.

Statement 22. An agricultural device is provided according to Statements 11-21, wherein the device serves to inhibit the activity of pests from the general area of a plant with which the device is associated.

Statement 23. An agricultural device is provided according to Statements 11-22, wherein the device serves to reduce the watering needs of a planting with which it is associated through its moisture retention capability.

Statement 24. A method for stimulating root development is provided that includes the step of applying an agricultural composition of Statements 11-23, or agricultural device of Statements 1-10, or a combination thereof, to the surface of the at least one plant, the surrounding soil, turf, seed, or a combination thereof, wherein upon application, root development is stimulated.

Statement 25. A method of improving the quality or health of at least one target plant is provided that includes the step of applying an agricultural composition of Statements 11-23, or agricultural device of Statements 1-10, or a combination thereof to the surface of the at least one plant, the surrounding soil, turf, seed, or a combination thereof, wherein up application, the quality or health of the at least one target plant is improved.

Statement 26. A method of increasing crop yield is provided that includes the step of applying an agricultural composition Statements 11-23, or agricultural device of Statements 1-10, or a combination thereof to the surface of the at least one plant, the surrounding soil, turf, seed, or a combination thereof, wherein upon application, crop yield is increased.

Statement 27. A method of deterring pests from a plant is provided that includes the step of applying an agricultural composition of Statements 11-23, or agricultural device of Statements 1-10, or a combination thereof to the surface of the at least one plant, the surrounding soil, turi, seed, or a combination thereof, wherein upon application, one or more pests are deterred.

Statement 28. A method of increasing moisture retention for a plant is provided that includes the step of applying an agricultural composition of Statements 11-23, or agricultural device of Statements 1-10, or a combination thereof to the surface of the at least one plant, the surrounding soil, turf, seed, or a combination thereof, wherein upon application, moisture retention is increased.

What is claimed is:

1. An agricultural composition comprising:
at least one keratin protein isolated from at least one feather;
at least one keratin protein isolated from human hair; and
at least one carrier.

2. The agricultural composition according to claim 1, wherein the at least one feather and human hair each comprise a total nitrogen content of from about 0.5% w/w to about 5.0% w/w nitrogen.

3. The agricultural composition according to claim 1, comprising:
from about 0.5% v/v to about 5.0% v/v of the at least one keratin protein isolated from at least one feather; and
from about 0.5% v/v to about 5.0% v/v of the at least one keratin protein isolated from human hair; and
the remainder at least one carrier,
wherein the volume percentages are based on the total volume of the agricultural composition.

4. The agricultural composition according to claim 1, further comprising moringa, feather meal, or a combination thereof.

5. The agricultural composition according to claim 1, wherein upon application to a plant, the plant growth is increased by at least about 5% compared to an plant that is not subject to application of the agricultural composition.

6. The agricultural composition according to claim 1, wherein each of the at least one keratin protein isolated from at least one feather and at least one keratin protein isolated from human hair are formulated as a slurry.

7. An agricultural device comprising:
an agricultural composition comprising:
at least one keratin protein isolated from at least one feather;
at least one keratin protein isolated from human hair; and
at least one carrier; and
a multi-function horticultural device comprising:
a plurality of individual natural fibers intertwined such that the multi-function horticultural device has a density from generally about 0.02 to generally about 3 grams of the individual natural fibers per cubic inch,
wherein the multi-function horticultural device is capable of holding and retaining from generally about 0.02 to generally about 15 grams of agricultural composition per cubic inch.

8. The agricultural device according to claim 7, wherein the multi-function horticultural device includes at least one natural fiber from the group including human hair, animal hair, coconut fiber, seaweed, kelp, cotton, corn silk and peat moss.

9. The agricultural device according to claim 7, wherein the multi-function horticultural device further comprises a plurality of man-made fibers.

10. The agricultural device according to claim 7, wherein the agricultural composition comprises:
from about 0.5% v/v to about 5.0% v/v of the at least one keratin protein isolated from at least one feather;
from about 0.5% v/v to about 5.0% v/v of the at least one keratin protein isolated from human hair; and
the remainder at least one carrier,
wherein the volume percentages are based on the total volume of the agricultural composition.

11. The agricultural device according to claim 7, wherein the agricultural composition further comprises moringa, feather meal, or a combination thereof.

12. The agricultural device according to claim 7, wherein each of the at least one keratin protein isolated from at least one feather and at least one keratin protein isolated from human hair are formulated as a slurry.

13. A method of increasing crop yield of at least one plant, the method comprising the step of:
applying an agricultural composition to a surface of the plant, surrounding soil, turf, seed, or a combination thereof, agricultural composition comprising:
at least one keratin protein isolated from at least one feather;
at least one keratin protein isolated from human hair; and
at least one carrier,
wherein upon application, crop yield is increased.

14. The method of claim 13, further comprising the step of:
introducing a multi-function horticultural device to the surrounding soil that includes the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch,
wherein the multi-function horticultural device is capable of holding and retaining from generally about 0.02 to generally about 15 grams of agricultural composition per cubic inch.

15. The method of claim 13, wherein upon application to the surface of a plant, the plant growth is increased by at least about 5% compared to an plant that is not subject to application of the agricultural composition.

16. The method of claim 13, wherein each of the at least one keratin protein isolated from at least one feather and at least one keratin protein isolated from human hair are formulated as a slurry.
